(19) United States
(12) Patent Application Publication
(10) Pub. No.: US 2008/0105753 A1
(43) Pub. Date: May 8, 2008

(54) Modulating electrical reheat with contactors

(75) Inventors: Peter Ring Carlsen, Aalborg (DK); Martin Hopfner Kirkmand, Odense So (DK)

Correspondence Address: LOWRIE, LANDO & ANASTASI, LLP, ONE MAIN STREET, SUITE 1100, CAMBRIDGE, MA, 02142, US

(73) Assignee: American Power Conversion Corporation, West Kingston, RI (US)

(21) Appl. No.: 11/592,612

(22) Filed: Nov. 3, 2006

(51) Int. Cl. G05D 23/12; F25D 23/12

(52) U.S. Cl. 236/1 C; 62/259.2

(57) ABSTRACT

A method of controlling an output temperature of an air conditioning unit including acts of drawing an air flow into the unit to create an air flow through the unit, directing the air flow across a plurality of heating elements, including a first heating element and a second heating element, generating a first pulse width modulated (PWM) control signal, applying the first PWM control signal to a first contactor to control the first heating element to heat the-air flow, generating a second pulse width modulated control signal that is phase shifted from the first PWM control signal, and applying the second PWM control signal to a second contactor to control the second heating element to heat the air flow. Cooling systems and further embodiments are also disclosed.

### BACKGROUND OF INVENTION

1. Field of Invention

Embodiments of the invention relate generally to devices and methods for heating a fluid flow to an object. Specifically, aspects of the invention relate to methods of heating an air flow by controlling multiple contactors with phase shifted pulse width modulated control signals to provide power to a plurality of heating elements.

2. Discussion of Related Art

Regulation of the temperature of electronic equipment may be critical to the proper operation of the equipment. Overheating, overcooling and temperature fluctuations can have adverse effects on the performance, reliability and useful life of the electronic equipment.

A typical environment where temperature control may be crucial to the reliable operation of electronic equipment includes a data center containing racks full of electronic equipment, such as servers and CPUs. As demand for processing power has increased, data centers have increased in size so that a typical data center may now contain hundreds of such racks. Furthermore, as the size of electronic equipment has decreased, the amount of electronic equipment in each rack has increased. An exemplary industry standard rack is approximately six to six-and-a-half feet high, by about twenty-four inches wide, and about forty inches deep. Such a rack is commonly referred to as a “nineteen inch” rack, as defined by the Electronics Industries Association's EIA-310-D standard.

To address heat generated by electronic equipment, such as the rack-mounted electronic equipment of a modern data center, air cooling devices have been used to provide a flow of cool air to the electronic equipment. In the data center environment, such cooling devices are typically referred to as computer room air conditioner (“CRAC”) units. These CRAC units generally intake warm air from the data center and output cooler air into the data center. The temperature of air taken in and output by such CRAC units may vary depending on the cooling needs and arrangement of a data center. In general, such CRAC units intake room temperature air at about 72° F. and discharge colder air at below about 60° F.

In some situations, the electronic equipment may require heating to maintain the electronic equipment at an optimal temperature. Such a situation may, for example, occur during low activity periods (e.g., late night) in data centers disposed in cold climates, or during a dehumidification process performed by a CRAC unit in which excess cooling capacity is produced by a cooling device of the CRAC unit in order to lower the relative humidity of an air flow. To address the need for heating in these situations, air heating devices have been used to provide a flow of warm air to the electronic equipment or reheat the over-cooled flow of air in a dehumidification process before it reaches the electronic equipment. The heating devices are generally disposed within a flow of air between the cooling devices and the electronic equipment.

Some heating devices may include a single heating element that may be capable of generating only a single non-variable maximum heating output. Other heating devices may include multiple such heating elements. The total output of such a heating device may be varied by changing the number of heating elements generating heat. Such an arrangement allows a heating device to produce one of a discrete number of heating outputs that correspond to the number of non-variable heating elements generating heat.

The heating elements may be controlled by a semiconductor-based switch. The switch may provide power to the heating elements according to a desired heating condition. The switch, for example, may provide power to a number of heating elements needed to generate a desired heating output that most closely corresponds to the heating capacity needed to maintain a data center at a desired temperature.

### SUMMARY OF INVENTION

One aspect of the invention includes a method of controlling an output temperature of an air conditioning unit. The method includes drawing an air flow into the unit to create an air flow through the unit, directing the air flow across a plurality of heating elements, including a first heating element and a second heating element, generating a first pulse width modulated (PWM) control signal, applying the first PWM control signal to a first contactor to control the first heating element to heat the air flow, generating a second pulse width modulated control signal that is phase shifted from the first PWM control signal, applying the second PWM control signal to a second contactor to control the second heating element to heat the air flow.

In some embodiments, the method further comprises controlling at least one cooling element to cool the air flow. In some embodiments, the method further comprises directing the air flow to at least one piece of electronic equipment. In some embodiments, directing the air flow includes directing the air flow to at least one equipment rack housing the at least one piece of electronic equipment. In some embodiments, the first contactor supplies power to the first heating element during a high voltage portion of the first PWM control signal, and the second contactor supplies power to the second heating element during a second high voltage portion of the second PWM control signal. In some embodiments, the first contactor does not supply power to the first heating element during a low voltage portion of the first PWM control signal and the second contactor does not supply power to the second heating element during a second low voltage portion of the second PWM control signal.

In some embodiments, the method further comprises determining a first width of the first PWM control signal and a second width of the second PWM control signal based, at least in part, on a desired heating capacity of the first and second heating elements. In some embodiments, the first width corresponds to a first percentage of time during which the first PWM control signal operates at the first high voltage portion and the second width corresponds to a second percentage of time during which the second PWM control signal operates at the second high voltage portion. In some embodiments, the first percentage is the same as the second percentage. In some embodiments, the first and second percentages correspond to percentages of a maximum output heating capacity of the first and second heating elements, respectively. In some embodiments, the plurality of heating elements includes at least one third heating element, and the method further comprises generating at least one third pulse width modulated control signal that is phase shifted from the first PWM control signal and the second PWM control signal, and applying the at least one third PWM control signal to at least one third contactor to control at least one third heating element.

One aspect of the invention includes a system for providing an air flow at a controlled temperature. In some embodiments, the system comprises at least one first heating element coupled to at least one power source through at least one first contactor and configured to heat the air flow, at least one second heating element coupled to the at least one power source through at least one second contactor and configured to heat the air flow, and a controller configured to operate the at least one first heating element with a first pulse width modulated (PWM) control signal and to operate the at least one second heating element with a second PWM control signal that is phase shifted from the first PWM control signal.

In some embodiments, the system further comprises at least one cooling element configured to cool the air flow. In some embodiments, the system further comprises a directing element configured to direct the air flow to at least one piece of electronic equipment. In some embodiments, the directing element is configured to direct the air flow to at least one rack in which the at least one piece of electronic equipment is housed. In some embodiments, the controller operates the at least one first heating element by providing the first PWM control signal to the at least one first contactor, and wherein the controller operates the at least one second heating element by providing the second PWM control signal to the at least one second contactor. In some embodiments, the at least one first contactor is configured to supply the at least one first heating element with power during a first high voltage portion of the first PWM control signal, and wherein the at least one second contactor is configured to supply the at least one second heating element with power during a second high voltage portion of the second PWM control signal.

In some embodiments, the at least one first contactor is configured to not supply the at least one first heating element with power during a first low voltage portion of the first PWM control signal, and wherein the at least one second contactor is configured to not supply the at least one second heating element with power during a second low voltage portion of the second PWM control signal. In some embodiments, the controller is configured to determine a first width of the first PWM control signal and a second width of the second PWM control signal based, at least in part, on a desired heating capacity. In some embodiments, the first width corresponds to a first percentage of a heating period during which the first PWM control signal operates at the high portion of the first PWM control signal, and the second width corresponds to a second percentage of a heating period during which the second PWM control signal operates at the high portion of the second PWM control signal. In some embodiments, the first percentage is the same as the second percentage. In some embodiments, the first and second percentages correspond to percentages of a maximum output heating capacity of the first and second heating elements, respectively. In some embodiments, the system further comprises at least one third heating element coupled to the at least one power source through at least one respective third contactor, and wherein the controller is further configured to control the at least one third heating element with at least one respective third PWM control signal that is phase shifted from the first and second PWM control signals.

One aspect of the invention includes a system for providing an air flow at a controlled temperature. In some embodiments, the system comprises at least one first heating element coupled to at least one power source through at least one first contactor, at least one second heating element coupled to the at least one power source through at least one second contactor, and a means for operating the at least one first contactor with a first pulse width modulated control signal and for operating the second contactor with a second pulse width modulated control signal that is phase shifted from the first pulse width modulated control signal.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a CRAC unit of an embodiment of the invention;

FIG. 2 is a diagram of components of a heating device of an embodiment of the invention;

FIG. 3 is a graph of control signals and heating output of an embodiment of the invention;

FIG. 4 is a graph of control signals and heating output of an embodiment of the invention; and

FIG. 5 is a graph of control signals and heating output of an embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In accordance with one aspect of the invention, it is recognized that traditional heating devices may require expensive components and not provide sufficiently variable heating output. At least one embodiment of the invention relates generally to a heating device using widely available components to provide variable heating. Particularly, in at least one embodiment of the invention, a plurality of electrical contactors control power supplied to a plurality of heating elements of a heating device. The contactors may be controlled by pulse width modulated (PWM) control signals that are each phase shifted from one another.

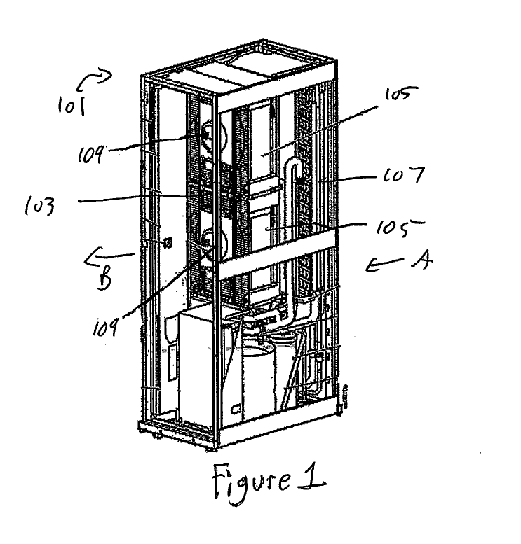

At least one embodiment of the present invention includes a CRAC unit. Examples of CRAC units are described in detail in U.S. patent application Ser. No. 11/335,874 filed Jan. 19, 2006 and entitled “COOLING SYSTEM AND METHOD,” Ser. No. 11/335,856 filed Jan. 19, 2006 and entitled “COOLING SYSTEM AND METHOD,” Ser. No. 11/335,901 filed Jan. 19, 2006 and entitled “COOLING SYSTEM AND METHOD,” Ser. No. 11/504,382 filed Aug. 15, 2006 entitled “METHOD AND APPARATUS FOR COOLING,” and Ser. No. 11/504,370 filed Aug. 15, 2006 and entitled “METHOD AND APPARATUS FOR COOLING” which are hereby incorporated herein by reference. In some embodiments of the invention, a cooling unit, such as the CRAC unit 101 illustrated in FIG. 1, may include a heating device 103 comprising one or more heating elements each indicated at 105.

In one embodiment, the heating elements 105 may be configured to heat an air flow through the CRAC unit 101. The arrangement may be such that as air moves by or through the heating elements 105, the air is heated. The heating elements 105 may include any type of heat exchanger or heater, including an air-cooled heat exchanger, which is sown in FIG. 1, a plate heat exchanger, a gasket heat exchanger, a gas heater, an electric heater, a hot gas reheat system, a heating element that uses heated coolant, etc. In one implementation, the heating elements 105 may be disposed in an air flow (indicated by arrows A and B) between a cooling device 107 (e.g., an evaporator) and the electronic equipment to be cooled by the CRAC unit 101. In another implementation, the cooling device 107 may be disposed in an air flow between the heating element 105 and the electronic equipment.

In one embodiment, the air flow over or through the heating elements 105 may be generated by one or more air moving devices. In one embodiment, the air moving device may include one or more fans each indicated at 109 in FIG. 1. The one or more fans 109 may be capable of operating at a non-variable, semi-variable and/or fully-variable fan speed.

Some conventional CRAC units may include a single heating element (e.g., 105). Such a heating element may not generally produce fully variable heating output, but rather may produce only a characteristic maximum output heating capacity or one of a discrete set of outputs. Other conventional CRAC units may include multiple heating elements acting as a matrix of heating elements (e.g., 105) to produce a heating output. Such heating elements (e.g., 105) may act together to produce a more variable heating output based on the number of heating elements (e.g., 105) generating heat at one time. The conventional use of multiple heating elements (e.g., 105), however, still does not produce a fully variable heating output. Also, typical heating elements in a CRAC unit are controlled by expensive semiconductor-based switching technology. Such technology may be expensive and difficult to replace if damaged.

In operation of heating elements (e.g., 105) in a CRAC unit (e.g. 101), the heating elements (e.g., 105) may heat an air flow to electronic equipment in a data center to prevent a data center temperature from falling below a minimum temperature, for example, during a dehumidification process or in a cold environment. Another use of heating elements (e.g., 105) in a CRAC unit (e.g., 101) is to provide continuous cooling capacity, which is described in U.S. patent application Ser. No. ______ by Carlsen, et al., filed on Nov. 3, 2006, entitled “CONTINUOUS COOLING CAPACITY REGULATION USING SUPPLEMENTAL HEATING,” and having attorney docket number A2000-705719, and which is hereby incorporated herein by reference. That application describes the use of a heating device (e.g., 103) to heat an air flow in combination with a cooling device (e.g., 107) configured to cool the air flow. The combined heating and cooling produces a more variable total cooling capacity than would be producible by the cooling device (e.g., 107) alone.

It should be appreciated, however, that descriptions of heating elements (e.g., 105), heating device (e.g., 103), cooling devices, CRAC units (e.g., 101) and their uses are given by way of example only. Embodiments of the invention may include any type of heating devices (e.g., 103) comprising any type and number of heating elements (e.g., 105) configured to heat air and/or any other type of fluid, including liquid and gas. At least one embodiment of the invention may include any type of fluid moving device including fans, pipes, tubes, valves, directing surfaces, pumps, vents, etc., configured to move fluid through and/or over the heating elements. Moreover, the invention is not limited to the heating and/or cooling of electronic equipment. Rather, embodiments of the invention may include any type of device configured to heat and/or cool a fluid flow to any type of object or space. Some implementations of the invention may include InRow RP Chilled Water Systems available from APC, Corp., West Kingston, R.I., Network AIR IR 20 KW Chilled Water Systems available from APC, Corp., West Kingston, R.I., FM CRAC Series Systems available from APC, Corp., West Kingston, R.I., and/or any other heating or precision cooling equipment where variable heating is desired.

In accordance with one aspect of the invention, it is recognized that a heating element (e.g., 105) may not instantaneously change from generating a first amount of heat to generating a target amount of heat. Rather, the heating element (e.g., 105) may have a response time during which the amount of heat generated by the heating element (e.g., 105) gradually changes from the first amount of heat to the target amount of heat. The response time may be affected by the design and mass of the heating element, such that heating elements (e.g., 105) with a larger mass may have a longer response time. A typical measurement used to characterize the response time of heating elements (e.g., 105) is a sixty-six percent response time (i.e., the time needed to change from not generating any heat to generating sixty-six percent of the maximum output heating capacity of the heating elements). Typical sixty-six response times of heating elements (e.g., 105) may range between about five and about fifteen seconds.

In another aspect of the invention, it is recognized that well-known contactors, such as the DP, IEC, and NEMA contactors available from General Electric Company, Fairfield, Conn., are widely available and relatively inexpensive compared with specialized semiconductor switching technologies conventionally used to control heating elements (e.g., 105). Such contactors are readily available, inexpensive, and typically easily replaced if damaged.

In typical operation, one type of contactor used with at least one embodiment may allow current to flow through the contactor when a voltage (e.g., a relatively high voltage) is applied across a coil of the contactor, and the contactor will not allow current to flow through the contactor when no voltage (e.g., a relatively low voltage) is applied across the coil. In one implementation, the current allowed to flow may include a relatively high current load (e.g., between one Amp and one thousand Amps).

Typically, contactors may function for a limited number of switching cycles (i.e., changes in whether current is allowed to flow through the contactor). The number of switching cycles may vary depending, in part, on the magnitude of the current being switched. For example, the more current, the fewer number of switching cycles may be available during the useful life of the contactor. A typical contactor may switch between about 200,000 and about 10,000,000 times before failing. A contactor may require replacement after such a failure, and because of the wide availability and relative affordability of replacement contactors, failed contactors may be easily replaced. This is in stark contrast to replacing a failed semiconductor switch which may require expensive replacements that are difficult to obtain locally and require dedicated internal cooling to function properly. Some example contactors that may be used in implementations of the invention include contactor models A16-30-10-81 and A9-30-10-81 available from ABB, Inc., Norwalk Conn. and contactor models 101-0091B, 101-0092B, and 101-0093B available from Creative Assemblies, Inc., Columbia, Md.

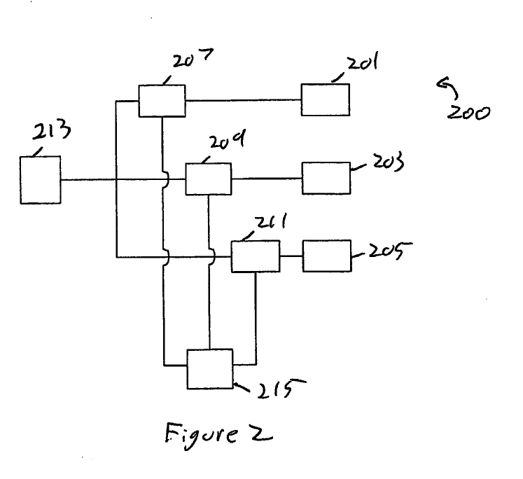

In accordance with one aspect of the invention, relatively cheap, reliable, and widely available contactors, which require little cooling to operate, may be used to regulate power supplied to heating elements (e.g., 105) to generate variable total heating output of the heating device (e.g., 103). The use of contactors with phase shifted PWM control signals, as described below, produces a convenient power switch with a relatively long useful life time. FIG. 2 illustrates a block diagram of one embodiment of the invention having a heating device 200 comprising three heating elements 201, 203, and 205. Each heating element 201, 203, and 205 may be configured to heat an air flow, as described above. The block diagram of FIG. 2 illustrates a contactor (e.g., 207, 209, 211) placed between each respective heating element 201, 203, and 205 and a power supply 213. In one embodiment, the power supply 213 may be configured to supply enough power to operate all of the heating elements 201, 203, and 205 simultaneously.

The switching of the contactors 207, 209, and 211 may be controlled by a controller 215 coupled to the contactors 207, 209, and 211. For example, the controller 215 may be configured to selectively supply a voltage across contactor coils of each of contactors 207, 209, and 211 so that when the voltage is supplied, the respective contactor (e.g., 207) is switched on to supply power to its respective heating element (e.g., 201) from the power supply 213. Although not shown in FIG. 2, the controller 215 may also be coupled to the power supply 213 to control the operation of the power supply.

In one embodiment, the controller 215 may include a heat controller that may be part of heating device 200. In one embodiment, the heat controller may be configured to receive a main heating control signal indicating a desired total heating output (e.g., a percentage of total heating output) of the heating device. The main heating control signal may be received, for example, over a communication network from another controller, such as a cooling unit (e.g., CRAC unit 101) controller. The heating controller may determine a set of PWM control signals based on the desired heating output, as described below. In another embodiment, the controller 215 may include a cooling unit (e.g., CRAC unit 101) controller configured to control a heating device (e.g., 200) by providing control signals directly to the contactors (e.g., 207, 209, 211) over a communication network to vary the total heating output to a desired level, as described below. In one implementation, the controller may be either an analog or a digital controller. In one implementation, the controller 215 may include a Philips XAG49 microprocessor, available commercially from the Phillips Electronics Corporation North America, New York, N.Y.

In accordance with one aspect of the invention, relatively smooth and variable heating may be supplied by controlling contactors (e.g., 207, 209, 211) that regulate power supplied to a plurality of heating elements (e.g., 201, 203, 205) with PWM control signals that are phase shifted from one another. Such phase shifted PWM control signals used to control a plurality of heating elements may extend the useful life of each contactor compared to a contactor controlling a single heating element at the same temperature outputs as the plurality of heating elements.

In particular, each contactor (e.g., 207, 209, 211) may be configured to supply power to a respective heating element (e.g., 201, 203, 205) during a high voltage portion of its respective PWM control signal and not supply power to the respective heating element (e.g., 201, 203, 205) during a low voltage portion of its respective PWM control signal. In such an arrangement, the width of the pulse of each control signal may correspond to approximately the percentage of time a heating element (e.g., 201, 203, 205) is supplied with power during the heating cycle.

Furthermore, in one aspect of the invention, it is recognized that switching contactors (e.g., 207, 209, 211) to supply power to heating elements (e.g., 201, 203, 205) based on phase shifted PWM control signals may reduce the number of switches needed to maintain a relatively smooth heating output of a heating device (e.g., 200). As described below, each contactor (e.g., 207, 209, 211) may only require a single switch on and a single switch off during a heating cycle of a heating device (e.g., 200) in accordance with at least one embodiment of the invention. To produce equally smooth heating output from non-phase shifted PWM controlled heating elements (e.g., 201, 203, 205), each heating element (e.g., 201, 203, 205) may need to be switched on and off at a greater rate, decreasing the useful life of the contactors (e.g., 207, 209, 211). Furthermore, by including multiple heating elements operated independently through respective PWM signals, embodiments of the invention may provide for built in redundancy such that if one contactor or heating element fails, the remaining contactors or heating elements may still function properly.

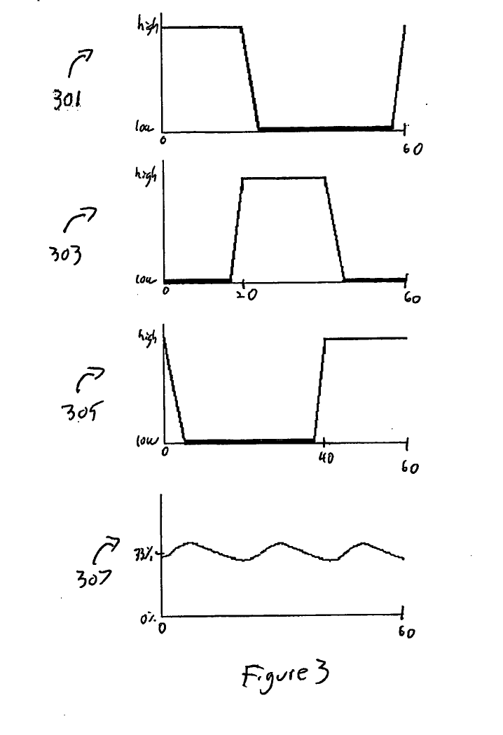

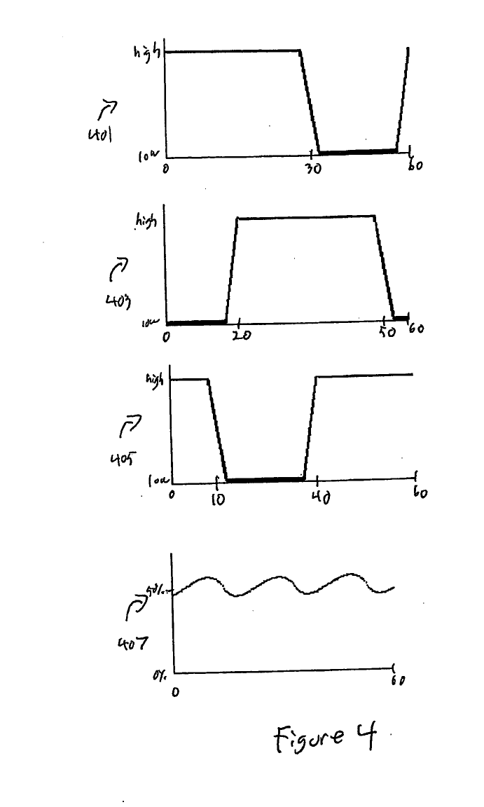

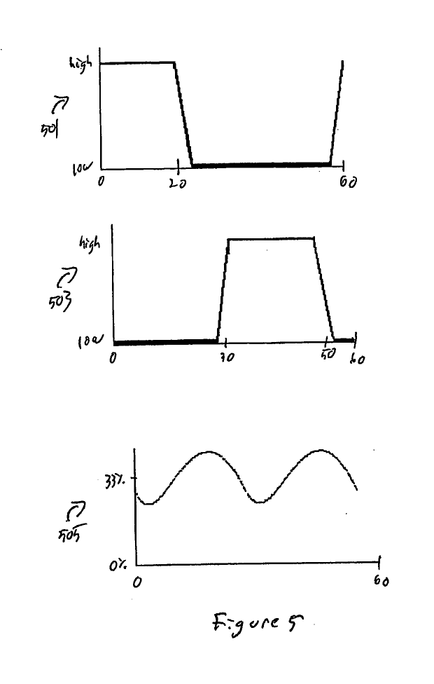

FIGS. 3, 4, and 5 illustrate control signals transmitted to contactors (e.g., 207, 209, 211) from a controller (e.g., 213) and total heat output of controlled heating devices from three embodiments of the invention. FIGS. 3 and 4 illustrate control signals and heat output of a heating device that includes three heating elements. FIG. 5 illustrates control signals and heating output of a heating device that includes two heating elements.

In one embodiment, as illustrated in FIGS. 3, 4, and 5, the control signals for each contactor may be equally phase shifted throughout a heating cycle. For example, graphs 301, 303, and 305 illustrate PWM control signals that vary between a low voltage (e.g., zero Volts) and a high voltage (e.g., twenty-four Volts) to operate a contactor (e.g., 207, 209, and 211).

In one embodiment, the heating cycle may be sixty seconds as indicated in FIGS. 3, 4, and 5. A first control signal may begin at zero seconds as indicated in graph 301. A second control signal may be phase shifted by twenty seconds so as to begin at 20 seconds into the heating cycle as indicated in graph 303. A third control signal may be phase shifted an additional twenty seconds so as to begin at forty seconds into the heating cycle as indicated in graph 305. The heating cycle may begin again at the sixty second point with the first control signal, so that every twenty seconds one of the three control signals may begin.

In operation, when the first control signal illustrated in graph 301 is in a high voltage state, the first contactor (e.g., 207) may supply the first heating element (e.g., 201) with power from a power supply (e.g., 213), such that a graph 301 of power supplied to the first heating element (e.g., 201) would look substantially similar to the graph of the control signal. When the first heating element (e.g., 201) is supplied with power, it may begin to radiate heat. However, as described above, the first heating element (e.g., 201) may have a response time such that the heat radiated from it may be less than the total maximum heat output of the heating element (e.g., 201). The first heating element (e.g., 201) may increase the amount of heat produced as power is supplied until the first heating element (e.g., 201) is producing its maximum heating output. However, in one embodiment, the first control signal may return to a low voltage state stopping the power supply to the first heating element (e.g., 201) before the first heating element reaches its maximum heating output.

Whenever the control signal returns to a low voltage state, the first contactor (e.g., 207) may stop supplying power to the first heating element (e.g., 201). The first heating element (e.g., 201) may then stop generating heat. However, as discussed above, the first heating element (e.g., 201) may not instantaneously stop generating heat. Instead, the first heating element (e.g., 201) may have a heating response time during which it may still generate some heat.

In operation, the second control signal illustrated in graph 303 may have a substantially similar effect on a second heating element (e.g., 203) when operating the second control signal in a manner similar to the first control signal. Furthermore, the third control signal illustrated in graph 305 may have a substantially similar effect on a third heating element (e.g., 205).

In sum, total heating output generated by the on and off switching of three heating elements (e.g., 201, 203, 205) controlled by the control signals of graphs 301, 303, and 305 is illustrated in graph 307. The combined heating output may remain relatively constant despite changes in the heating output of each individual heating element (e.g., 201, 203, 205). The response time of each heating element (e.g., 201, 203, 205) aids in smoothing or otherwise normalizing the combined heat output because each heating element may continue to generate heat even when not supplied by power while another heating element (e.g., 201, 203, 205) begins to generate heat.

In one aspect of the invention, it is recognized that the width of the control signal may correspond to a percentage of the total maximum heating output of the heating device (e.g., 200). The pulse width may therefore be varied to adjust the heating output of the heating device (e.g., 200) to a desired percentage of a maximum heating output.

For example, in FIG. 3, each control signal illustrated in graphs 301, 303, and 305 is in a high voltage state for about thirty-three percent of the total heating cycle. Thus, the combined heating output of a heating device (e.g., 200) having the three heating elements (e.g., 201, 203, 205) controlled by the three control signals fluctuates around thirty-three percent of the total maximum output heating capacity of the heating device (e.g., 200), as illustrated in graph 307. FIG. 4 illustrates another set of control signals in graphs 401, 403, and 405. Each control signal in FIG. 4 is in a high voltage state for about 50% of the heating cycle. As indicated in graph 407, which illustrates the combine heating output of the three heating elements (e.g., 201, 203, 205) controlled by the control signals of graphs 401, 403, and 405, the heating output fluctuates around fifty percent of the total maximum output heating capacity of the heating device (e.g., 200).

In one embodiment, in which a heating device (e.g., 200) is used with a cooling device to produce a combined cooling output, the total combined cooling output may be adjusted such that:

Total Cooling=Cooling From Cooling Device−Heating From Heating Device. (1)

Total cooling may be adjusted to equal a desired total cooling by adjusting either the cooling from the cooling device or the heating from the heating device (e.g., 200). In one embodiment of the invention, the heating output may be varied by adjusting the time width of PWM control signals to contactors controlling power supplied to heating elements (e.g., 201, 203, 205) of the heating device (e.g., 200), as discussed above.

The smoothness of the combined heating output may be improved by adjusting heating factors (e.g., using heating elements with a different response time, using a different heating cycle time) and/or increasing the number of heating elements (e.g., 201, 203, 205). A variable X defined by the equation:

X=P/(R*N), (2)

where P equals the time of a full heating cycle, R equals the sixty-six percent response time of each heating element (e.g., 201, 203, 205), and N equals the number of heating elements (e.g., 201, 203, 205), describes the smoothness of the heating output. As X decreases, the smoothness of the heating output may increase. In typical operation, acceptable X values may range between 1 and 3; although, it should be appreciated that any X value may be used, depending on the use of a particular heating device (e.g., 200).

Graphs 501 and 503 of FIG. 5 illustrate heating control signals for a heating device that comprises two heating elements. Graph 505 illustrates the combined heating output of the two heating elements generated by the control signals of graphs 501 and 503. The control signals are in a high voltage state thirty-three percent of the heating period, similar to those of FIG. 3. Although the combined heating output fluctuates around thirty-three percent of the total maximum output heating capacity, similar to that of FIG. 3, the fluctuation of combined heating output (i.e., the differences in the highs and lows of the heating outputs) is greater in graph 505 than in graph 307 or graph 407. To illustrate the operation of the X variable, in the case of FIG. 4, where P=sixty seconds, N=three, and R=twenty seconds, X=1. In the case of FIG. 6, where P=sixty seconds, N=two, and R=twenty seconds, X=3/2.

It should be appreciated that the above graphs and sample operation outputs are described as examples only. The invention is not limited to any heating cycle time, response time, number of heating elements, or value of X from Equation 2.

Although embodiments of the invention have been described with respect to heating electronic equipment in data center environments, it should be recognized that embodiments of the invention are not so limited. Rather, embodiments of the inventions may be used to provide heating in any environment to any object and/or space. For example, embodiments of the invention may be used with telecommunication equipment in outdoor environments or shelters, telecommunication data centers, and/or mobile phone radio base-stations. Embodiments of the invention may be used to with precious goods such as art work, books, historic artifacts and documents, and/or excavated biological matters (for example, for preservation purposes). Embodiments of the invention may be used for preservation of meats, wines, spirits, foods, medicines, biological specimens and samples, and/or other organic substances. Further embodiments may be used for process optimization in biology, chemistry, greenhouse, and/or other agricultural environments. Still other embodiments may be used to protect against corrosion and/or oxidization of structures (for example, buildings, bridges, or large structures).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of controlling an output temperature of an air conditioning unit, the method comprising:
A) drawing an air flow into the unit to create an air flow through the unit;
B) directing the air flow across a plurality of heating elements, including a first heating element and a second heating element;
C) generating a first pulse width modulated (PWM) control signal;
D) applying the first PWM control signal to a first contactor to control the first heating element to heat the air flow;
E) generating a second pulse width modulated control signal that is phase shifted from the first PWM control signal; and
F) applying the second PWM control signal to a second contactor to control the second heating element to heat the air flow.

2. The method of claim 1, further comprising an act of G) controlling at least one cooling element to cool the air flow.

3. The method of claim 1, further comprising an act of G) directing the air flow to at least one piece of electronic equipment.

4. The method of claim 3, wherein the act G includes directing the air flow to at least one equipment rack housing the at least one piece of electronic equipment.

5. The method of claim 1, wherein the first contactor supplies power to the first heating element during a high voltage portion of the first PWM control signal, and the second contactor supplies power to the second heating element during a second high voltage portion of the second PWM control signal.

6. The method of claim 5, wherein the first contactor does not supply power to the first heating element during a low voltage portion of the first PWM control signal and the second contactor does not supply power to the second heating element during a second low voltage portion of the second PWM control signal.

7. The method of claim 5, further comprising an act of G) determining a first width of the first PWM control signal and a second width of the second PWM control signal based, at least in part, on a desired heating capacity of the first and second heating elements.

8. The method of claim 7, wherein the first width corresponds to a first percentage of time during which the first PWM control signal operates at the first high voltage portion and the second width corresponds to a second percentage of time during which the second PWM control signal operates at the second high voltage portion.

9. The method of claim 8, wherein the first percentage is the same as the second percentage.

10. The method of claim 8, wherein the first and second percentages correspond to percentages of a maximum output heating capacity of the first and second heating elements, respectively.

11. The method of claim 1, wherein the plurality of heating elements includes at least one third heating element, and wherein the method further comprises:
G) generating at least one third pulse width modulated control signal that is phase shifted from the first PWM control signal and the second PWM control signal; and
F) applying the at least one third PWM control signal to at least one third contactor to control at least one third heating element.

12. A system for providing an air flow at a controlled temperature, the system comprising:
at least one first heating element coupled to at least one power source through at least one first contactor and configured to heat the air flow;
at least one second heating element coupled to the at least one power source through at least one second contactor and configured to heat the air flow; and
a controller configured to operate the at least one first heating element with a first pulse width modulated (PWM) control signal and to operate the at least one second heating element with a second PWM control signal that is phase shifted from the first PWM control signal.

13. The system of claim 12, further comprising at least one cooling element configured to cool the air flow.

14. The system of claim 12, further comprising a directing element configured to direct the air flow to at least one piece of electronic equipment.

15. The system of claim 14, wherein the directing element is configured to direct the air flow to at least one rack in which the at least one piece of electronic equipment is housed.

16. The system of claim 12, wherein the controller operates the at least one first heating element by providing the first PWM control signal to the at least one first contactor, and wherein the controller operates the at least one second heating element by providing the second PWM control signal to the at least one second contactor.

17. The system of claim 16, wherein the at least one first contactor is configured to supply the at least one first heating element with power during a first high voltage portion of the first PWM control signal, and wherein the at least one second contactor is configured to supply the at least one second heating element with power during a second high voltage portion of the second PWM control signal.

18. The system of claim 17, wherein the at least one first contactor is configured to not supply the at least one first heating element with power during a first low voltage portion of the first PWM control signal, and wherein the at least one second contactor is configured to not supply the at least one second heating element with power during a second low voltage portion of the second PWM control signal.

19. The system of claim 12, wherein the controller is configured to determine a first width of the first PWM control signal and a second width of the second PWM control signal based, at least in part, on a desired heating capacity.

20. The system of claim 19, wherein the first width corresponds to a first percentage of a heating period during which the first PWM control signal operates at the high portion of the first PWM control signal, and the second width corresponds to a second percentage of a heating period during which the second PWM control signal operates at the high portion of the second PWM control signal.

21. The system of claim 20, wherein the first percentage is the same as the second percentage.

22. The system of claim 19, wherein the first and second percentages correspond to percentages of a maximum output heating capacity of the first and second heating elements, respectively.

23. The system of claim 12, further comprising at least one third heating element coupled to the at least one power source through at least one respective third contactor, and wherein the controller is further configured to control the at least one third heating element with at least one respective third PWM control signal that is phase shifted from the first and second PWM control signals.

24. A system for providing an air flow at a controlled temperature, the system comprising:
at least one first heating element coupled to at least one power source through at least one first contactor;
at least one second heating element coupled to the at least one power source through at least one second contactor; and
a means for operating the at least one first contactor with a first pulse width modulated control signal and for operating the second contactor with a second pulse width modulated control signal that is phase shifted from the first pulse width modulated control signal.
